(19) United States
(12) Patent Application Publication
(10) Pub. No.: US 2020/0201583 A1
(43) Pub. Date: Jun. 25, 2020

(54) IMAGE PROCESSING SYSTEM AND PORTABLE INFORMATION PROCESSING APPARATUS

(71) Applicant: TOSHIBA TEC KABUSHIKI KAISHA, Tokyo (JP)

(72) Inventors: Mei Yeen Wang, Singapore (SG); Jia Jiunn Kh'ng, Singapore (SG); Siew Whan Leaw, Singapore (SG); Noriyuki Watanabe, Mishima Shizuoka (JP)

(21) Appl. No.: 16/807,457

(22) Filed: Mar. 3, 2020

Related U.S. Application Data
(62) Division of application No. 16/414,835, filed on May 17, 2019.

(30) Foreign Application Priority Data
May 22, 2018 (JP) 2018-098145

(51) Int. Cl. G06F 3/12; H04W 4/80

(52) U.S. Cl. CPC G06F 3/1204; G06F 3/1231; G06F 3/1238; G06F 3/1292; G06F 3/126; H04W 4/80; G06F 3/1222

(57) ABSTRACT

In accordance with an embodiment, an image processing system comprises an image forming apparatus, a beacon transmitter, and a portable information processing apparatus. The image forming apparatus comprises image forming sections configured to execute an image forming job, and a communication section connected to a network. The beacon transmitter transmits a beacon including identification information for identifying the image forming apparatus. The portable information processing apparatus comprises a beacon reception section configured to receive a beacon including the identification information, a communication section connected to the network, and a control section configured to perform control to transmit information relating to the image forming job via the network to the image forming apparatus identified by the identification information included in the received beacon if the portable information processing apparatus enters a coverage area of the beacon transmitter and receives the beacon.

### CROSS-REFERENCE TO RELATED APPLICATIONS

This application is a Divisional of application Serial No. 16/414,835 filed on May 17, 2019, the entire contents of which are incorporated herein by reference.

This application is based upon and claims the benefit of priority from Japanese Patent Application No. 2018-098145, filed on May 22, 2018, the entire contents of which are incorporated herein by reference.

### FIELD

Embodiments described herein relate generally to an image processing system and a portable information processing apparatus.

### BACKGROUND

In recent years, for example, in an office, a printer is connected to a network, and is shared by a plurality of desktop PCs (Personal Computers). At the time of executing a job such as printing, the user can select a printer to execute the job from a printing operation screen displayed on a display of the desktop PC. When a plurality of printers is connected to the network, the plurality of printers is displayed on the printing operation screen.

For example, in the case of a portable information processing apparatus such as a tablet PC, a user is moving. Therefore, which one of the plurality of printers displayed on the printing operation screen is closest within the field of vision of the user may not be known in some cases. In particular, when information relating to the printer and displayed on the printing operation screen only includes a printer manufacturer name and a model number, if there are many printers of the same type, it is difficult for the user to distinguish the printers.

Further, at the time of maintenance, a worker who performs maintenance of the printer needs maintenance information stored in a storage section in the printer. The worker carries the portable information processing apparatus such as the tablet PC, for example, and connects the portable information processing apparatus with the printer via, for example, a USB (Universal Serial Bus) cable to acquire maintenance information. In this case, it is necessary to input a serial code of the printer.

### DESCRIPTION OF THE DRAWINGS

FIG. 1 is a diagram illustrating an overall configuration of a POS system incorporating an image processing system according to a first embodiment;

FIG. 2 is a block diagram of a POS terminal according to the first embodiment;

FIG. 3 is a block diagram of a maintenance terminal according to the first embodiment;

FIG. 4 is a perspective view illustrating an external appearance of a POS printer according to the first embodiment;

FIG. 5 is a cross-sectional view of the POS printer according to the first embodiment as viewed from a side surface side;

FIG. 6 is a block diagram of the POS printer according to the first embodiment;

FIG. 7 is a block diagram of a beacon transmitter according to the first embodiment;

FIG. 8 is a block diagram of a POS server according to the first embodiment;

FIG. 9 is a flowchart depicting a handshake processing performed by the image processing system according to the first embodiment;

FIG. 10 is a diagram illustrating the handshake processing performed by the image processing system according to the first embodiment;

FIG. 11 is a flowchart depicting a modification of the handshake processing performed by the image processing system according to the first embodiment;

FIG. 12 is a flowchart depicting a handshake processing performed by an image processing system according to a second embodiment; and

FIG. 13 is a diagram illustrating the handshake processing performed by the image processing system according to the second embodiment.

### DETAILED DESCRIPTION

In accordance with an embodiment, an image processing system comprises an image forming apparatus, a beacon transmitter, and a portable information processing apparatus. The image forming apparatus comprises an image forming section that executes an image forming job, and a communication sectionp connected to a network. The beacon transmitter transmits a beacon including identification information for identifying the image forming apparatus. The portable information processing apparatus comprises a beacon reception section configured to receive a beacon including the identification information, a communication section connected to the network, and a transmission section configured to transmit information relating to the image forming job via the network to the image forming apparatus identified by the identification information included in the received beacon if the portable information processing apparatus enters a coverage area of the beacon transmitter and receives the beacon.

Hereinafter, an image processing system and a portable information processing apparatus according to the embodiment are described in detail with reference to the accompanying drawings. In the drawings, the same reference numerals are denoted to the same components.

### First Embodiment

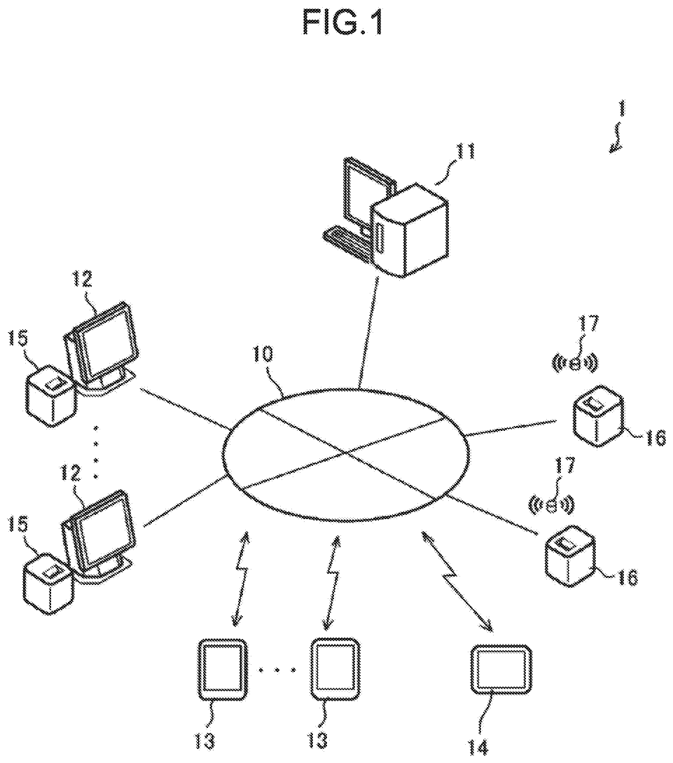

FIG. 1 is a diagram illustrating an overall configuration of a POS (Point of Sales) system 1 which manages a retail store such as a supermarket. The image processing system of the first embodiment is incorporated into the POS system 1. The POS system 1 includes a POS server 11 connected to a network 10. The POS server 11 is, for example, a cloud server or a local server. The POS server 11 collectively manages, for example, information relating to commodities sold in the retail store. The POS system 1 includes a plurality of terminal-type POS terminals 12 and a plurality of tablet-type POS terminals 13 as POS terminals connected to the network 10. The terminal-type POS terminal 12 and the tablet-type POS terminal 13 sequentially register commodities that a customer desires to purchase, and performs settlement on a purchase amount after registering all the commodities. The terminal-type POS terminal 12 is installed, for example, at a register counter. The tablet-type POS terminal 13 is carried by a store clerk or lent to a customer as a self-service device. A maintenance terminal 14 is used at the time of maintenance of POS printers 15 and 16. The tablet-type POS terminal 13 and the maintenance terminal 14 are examples of the portable information processing apparatus.

The POS printers 15 and 16 print a receipt on which details of the purchased commodity are recorded. The POS printer 15 is connected to the terminal-type POS terminal 12. The terminal-type POS terminal 12 transmits information relating to a printing job of a receipt to the POS printer 15 after registration and settlement of a commodity that the customer desires to purchase.

The POS printer 16 is connected to the network 10. The tablet-type POS terminal 13 transmits information relating to a printing job of a receipt to the POS printer 16 by a handshake described in detail below. A beacon transmitter 17 is arranged in the vicinity of the POS printer 16. The POS printer 16 and the beacon transmitter 17 constitute a one-to-one combination. The POS printer 16 and the beacon transmitter 17 may not be independent devices, and the POS printer 16 and the beacon transmitter 17 may be integrally formed. In order to reduce interference between beacons, an arrangement interval between the beacon transmitters 17 is set to, for example, 3 m or more.

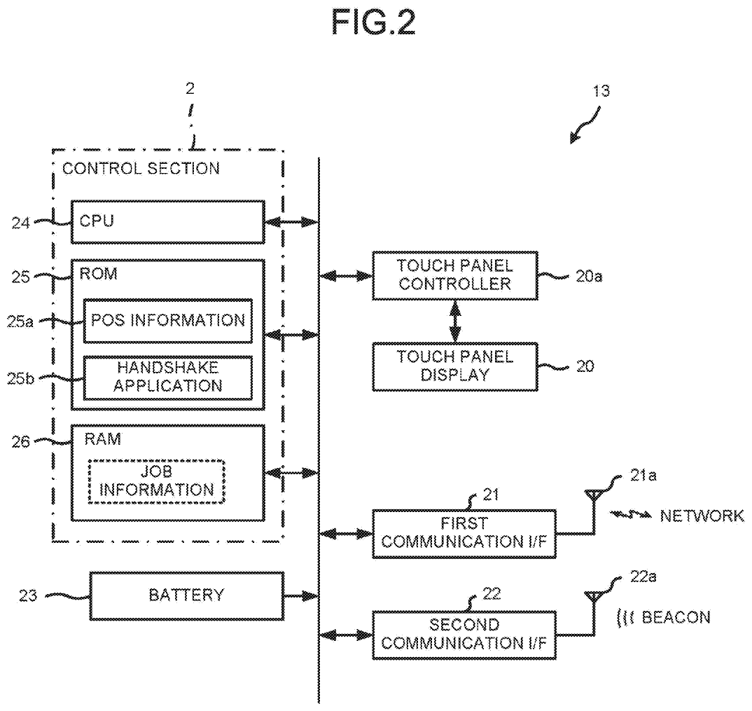

FIG. 2 is a block diagram of the tablet-type POS terminal 13. The tablet-type POS terminal 13 includes a control section 2, a touch panel display 20, a touch panel controller 20a, a first communication interface 21, a second communication interface 22 and a battery 23 which is a power supply. The respective components are mutually connected, for example via a system bus.

The control section 2 comprises a CPU (Central Processing Unit) 24, a ROM (Read Only Memory) 25 and a RAM (Random Access Memory) 26. The CPU 24, the ROM 25 and the RAM 26 are arranged on, for example, a circuit board. The CPU 24 controls the overall operation of the tablet-type POS terminal 13. The ROM 25 stores various programs and data. The data stored in the ROM 25 includes various kinds of POS information 25a necessary for performing registration and settlement of commodities. The RAM 26 stores various programs and data, and can rewrite various kinds of data.

The program stored in the ROM 25 includes an operating system and application programs for performing functions of the tablet-type POS terminal 13. The CPU 24 reads the program stored in the ROM 25 to execute it. The application programs include a handshake application 25b for establishing a communication path between two points of the tablet-type POS terminal 13 and the POS printer 16 by handshake to transmit data. The handshake between the tablet-type POS terminal 13 and the POS printer 16 includes a case of transmitting data by performing handshake with the POS printer 16 in which mutual communication method such as a communication speed and a data format is preset, and a case of transmitting data including confirmation of the communication method by performing handshake.

The touch panel display 20 has functions of both a display section and an operation section of the tablet-type POS terminal 13. The touch panel display 20 is, for example, a liquid crystal display or an organic EL (Electro-Luminescence) display provided with a touch sensor. The touch panel controller 20a controls an image display operation of the touch panel display 20. The touch panel controller 20a transmits information relating to a touch operation on the touch panel display 20 performed by a user such as a store clerk to the control section 2.

The first communication interface 21 is connected to the network 10. The first communication interface 21 establishes wireless communication with a communication device such as a router or an access point over the network 10 via an antenna 21a, for example. The control section 2 establishes wireless communication with the POS printer 16 and the POS server 11 connected to the network 10 via the first communication interface 21. The first communication interface 21 is an example of a communication section connected to the network 10 and is an example of a transmission section for transmitting a printing job.

The second communication interface 22 receives a beacon transmitted from the beacon transmitter 17. The second communication interface 22 receives the beacon transmitted from the beacon transmitter 17 via an antenna 22a and transmits the received beacon to the control section 2. The reception of the beacon is performed by a wireless communication technology such as Bluetooth® Technology or BLE (Bluetooth Low Energy), for example. The second communication interface 22 is an example of a beacon reception section that receives a beacon.

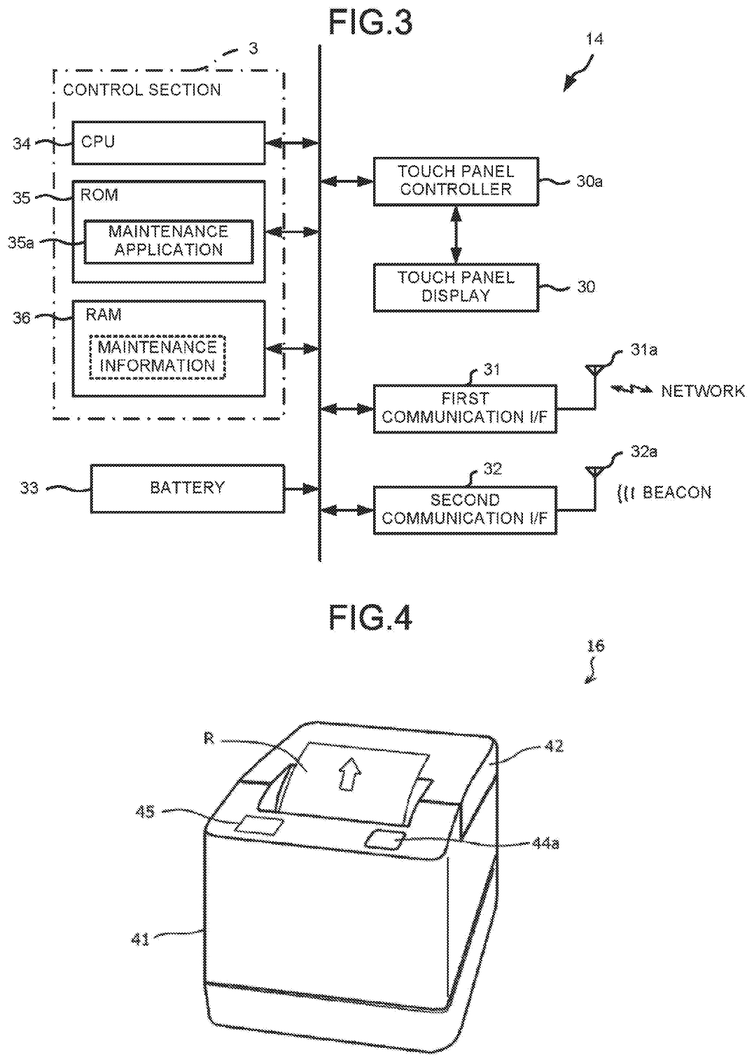

FIG. 3 is a block diagram of the maintenance terminal 14. The maintenance terminal 14 includes a control section 3, a touch panel display 30, a touch panel controller 30a, a first communication interface 31, a second communication interface 32 and a battery 33 which is a power supply. The respective components are mutually connected, for example via a system bus.

The control section 3 comprises a CPU 34, a ROM 35 and a RAM 36. The CPU 34, the ROM 35 and the RAM 36 are arranged on, for example, a circuit board. The CPU 34 controls the overall operation of the maintenance terminal 14. The ROM 35 stores various programs and data. The RAM 36 stores various programs and data, and can rewrite various kinds of data.

The program stored in the ROM 35 includes an operating system and application programs for performing functions of the maintenance terminal 14. The CPU 34 reads the program stored in the ROM 35 to execute it. The application programs include a maintenance application 35a for establishing a communication path between two points of the maintenance terminal 14 and the POS printer 16 to be maintained by handshake to receive maintenance information via the network 10.

The touch panel display 30 has functions of both a display section and an operation section of the maintenance terminal 14. The touch panel display 30 is, for example, a liquid crystal display or an organic EL display provided with a touch sensor. The touch panel controller 30a controls an image display operation of the touch panel display 30. The touch panel controller 30a transmits information relating to an operation on the touch panel display 30 performed by a user to the control section 3.

The first communication interface 31 is connected to the network 10. The first communication interface 31 establishes wireless communication with a communication device such as a router or an access point over the network 10 via an antenna 31a, for example. The control section 3 establishes wireless communication with the POS printer 16 and the POS server 11 connected to the network 10 via the first communication interface 31. The first communication interface 31 is an example of the communication section connected to the network 10 and is an example of the reception section for receiving the maintenance information.

The second communication interface 32 receives a beacon transmitted from the beacon transmitter 17. The second communication interface 32 receives the beacon transmitted from the beacon transmitter 17 via an antenna 32a and transmits the received beacon to the control section 3. The reception of the beacon is performed by a wireless communication technology such as Bluetooth® Technology or BLE, for example. The second communication interface 32 is an example of the beacon reception section that receives a beacon.

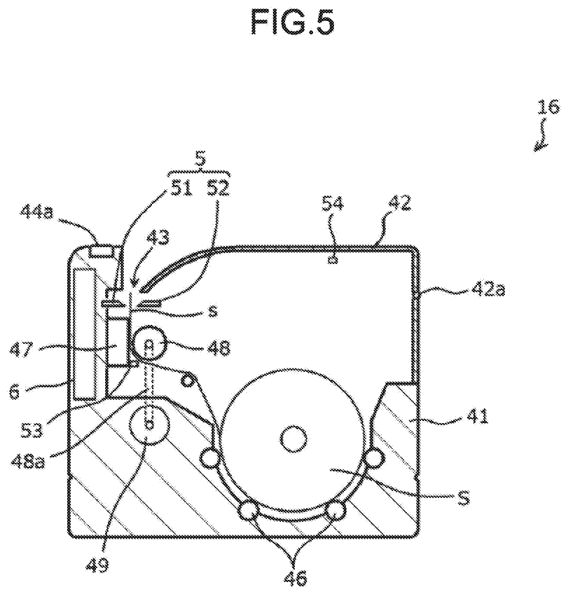

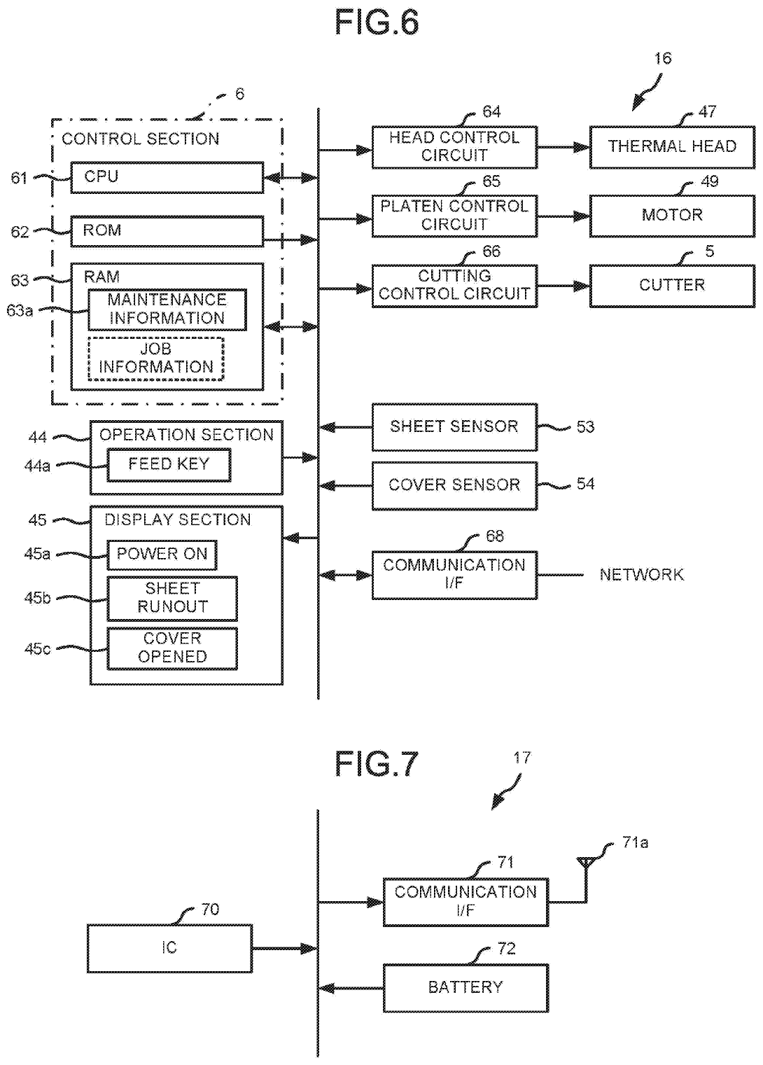

FIG. 4 is a perspective view illustrating an external appearance of the POS printer 16. FIG. 5 is a cross-sectional view of the POS printer 16 as viewed from a side surface side. FIG. 6 is a block diagram of the POS printer 16. The POS printer 16 is an example of the image forming apparatus.

The POS printer 16 is a thermal printer, for example. As shown in FIG. 4 and FIG. 5 in particular, in the POS printer 16, an exterior body is formed by a main body 41 and a cover 42. In the POS printer 16, a discharge port 43 for discharging a printed receipt R is arranged at the top of the main body 41. Further, in the POS printer 16, a FEED key 44a which is an operation section and a display section 45 are arranged at the top of the main body 41. The cover 42 is openable and closable in a vertical direction with a horizontal shaft 42a provided on a back surface of the main body 41 as a support axis. The cover 42 is opened and closed, for example, when a roll-shaped sheet S is placed in the main body 41. The roll-shaped sheet S is an example of a printing medium on which the receipt R is printed. The roll-shaped sheet S is, for example, a thermal paper.

The roll-shaped sheet S is rotatably supported by a plurality of supporting rollers 46. The plurality of supporting rollers 46 is arranged in parallel with a central shaft of the roll-shaped sheet S, respectively. A front end of the sheet S drawn out from the roll is conveyed towards the discharge port 43. A thermal head 47 and a platen roller 48 are arranged in the middle of a conveyance path of the sheet S. The thermal head 47 and the platen roller 48 constitute an example of an image forming section. The thermal head 47 is a print head in which heat generation elements for forming dots are arranged in a line, for example. The thermal head 47 is arranged in such a manner that a portion where the heat generation elements are arranged faces the platen roller 48 across the sheet S, and is biased towards the platen roller 48 by a biasing device (not shown) such as a spring.

In the platen roller 48, a portion in contact with the sheet S is made of a resin such as rubber. The platen roller 48 is connected to a motor 49 which is an example of a drive device via a power transmission device 48a such as a gear or a rotation belt. The motor 49 is, for example, a stepping motor. The platen roller 48 is rotated by a driving force from the motor 49. The thermal head 47 and the platen roller 48 synchronize a printing operation and a conveyance operation to perform printing on the sheet S.

A cutter 5 for cutting the sheet S is arranged between the discharge port 43 and a printing section (sheet pinching section) formed by the thermal head 47 and the platen roller 48. The cutter 5 includes a fixed blade 51 and a movable blade 52. The movable blade 52 is movable forward and backward with respect to the fixed blade 51. The cutter 51 cuts a rear end of the printed sheet S by moving the movable blade 52 forward and backward.

A sheet sensor 53 for detecting the presence of the sheet S is arranged, for example, in front of the printing section (sheet pinching section) formed by the thermal head 47 and the platen roller 48. A cover sensor 54 for detecting the opening and closing of the cover 42 is arranged, for example, in the vicinity of the cover 42. The sheet sensor 53 and the cover sensor 54 are, for example, optical sensors.

A control section 6 for controlling the overall operation of the POS printer 16 is arranged in the main body 41. As shown in the block diagram in FIG. 6, the control section 6 includes a CPU 61, a ROM 62 and a RAM 63. The CPU 61, the ROM 62 and the RAM 63 are arranged on a circuit board, for example. The CPU 61 controls the overall operation of the POS printer 16. The ROM 62 stores various programs and data. The RAM 63 stores various programs and data, and can rewrite various kinds of data. The data stored in the RAM 63 includes the maintenance information 63a and information relating to a printing job received from the tablet-type POS terminal 13. The RAM 63 is preferably nonvolatile.

A head control circuit 64 controls the printing operation of the thermal head 47. The control section 6 generates control signals such as dot arrangement information of an image to be printed, a latch signal, a strobe signal and the like based on the information relating to the printing job received from the tablet-type POS terminal 13, and then transmits the generated control signals to the head control circuit 64. A platen control circuit 65 controls operations of the motor 49 such as start and stop. The control section 6 transmits a control signal to the platen control circuit 65 to rotate the platen roller 48 in synchronization with the printing operation by the thermal head 47. A cutting control circuit 66 controls the operation of the cutter 5. The control section 6 transmits a control signal to the cutting control circuit 66 to cut the rear end of the sheet S after the printing is terminated.

The sheet sensor 53 detects whether or not there is a sheet S in front of the printing section (sheet pinching section) formed by the thermal head 47 and the platen roller 48. The control section 6 executes the printing operation if the sheet sensor 53 detects the sheet S, or transmits a signal “the sheet runs out” to the display section 45 without performing the printing operation if no sheet S is detected. The cover sensor 54 detects whether or not the cover 42 is closed. The control section 6 executes the printing operation if the cover sensor 54 detects that the cover is closed, or transmits a signal “the cover is open” to the display section 45 without performing the printing operation if the cover sensor 54 detects that the cover is opened.

An operation section 44 for operating the POS printer 16 includes the FEED key 44a. When a user presses the FEED key 44a, the control section 6 transmits a control signal to the platen control circuit 65 to rotate the platen roller 48 to feed the sheet S towards the discharge port 43. The display section 45 displays various statuses of the POS printer 16. The display section 45 includes an indicator lamp 45a for displaying a power ON state, an indicator lamp 45b for displaying that the sheet runs out, and an indicator lamp 45c for displaying that the cover is open. The display lamps 45a to 45c are, for example, LED (Light Emitting Diode) lamps.

A communication interface 68 is connected to the network 10. The communication interface 68 is connected to a communication device such as a router over the network 10 via a communication cable such as a LAN (Local Area Network) cable, for example. The control section 6 performs communication such as transmitting and receiving data with the tablet-type POS terminal 13 and the POS server 11 via the network 10 and the communication interface 68. The communication interface 68 is an example of the communication section connected to the network 10.

FIG. 7 is a block diagram of the beacon transmitter 17. The beacon transmitter 17 includes an IC (Integrated Circuit) 70, a communication interface 71 and a battery 72 which is a power supply. The respective components are mutually connected, for example, via a system bus.

The IC 70 generates a wireless signal (radio waves). The standard of the wireless signal generated by the IC 70 is, for example, Bluetooth Low Energy, and the wireless signal has, for example, a 2.4 GHz band. The IC 70 generates wireless signals at a time interval of, for example, 100 milliseconds. Furthermore, the IC 70 generates a signal indicating a beacon ID each time the wireless signal is generated. The beacon ID is unique identification information that distinguishes the beacon transmitter 17 from the other beacon transmitters 17.

The communication interface 71 transmits a beacon via an antenna 71a. When the IC 70 generates the wireless signal, the IC 70 superimposes the signals indicating the beacon IDs and repeatedly transmits them as beacons. A beacon is a near field wireless communication signal (radio wave) for communication within a coverage range of several meters to several tens of meters, for example. The battery 72 supplies electric power to the IC 70. The battery 72 is, for example, a cell.

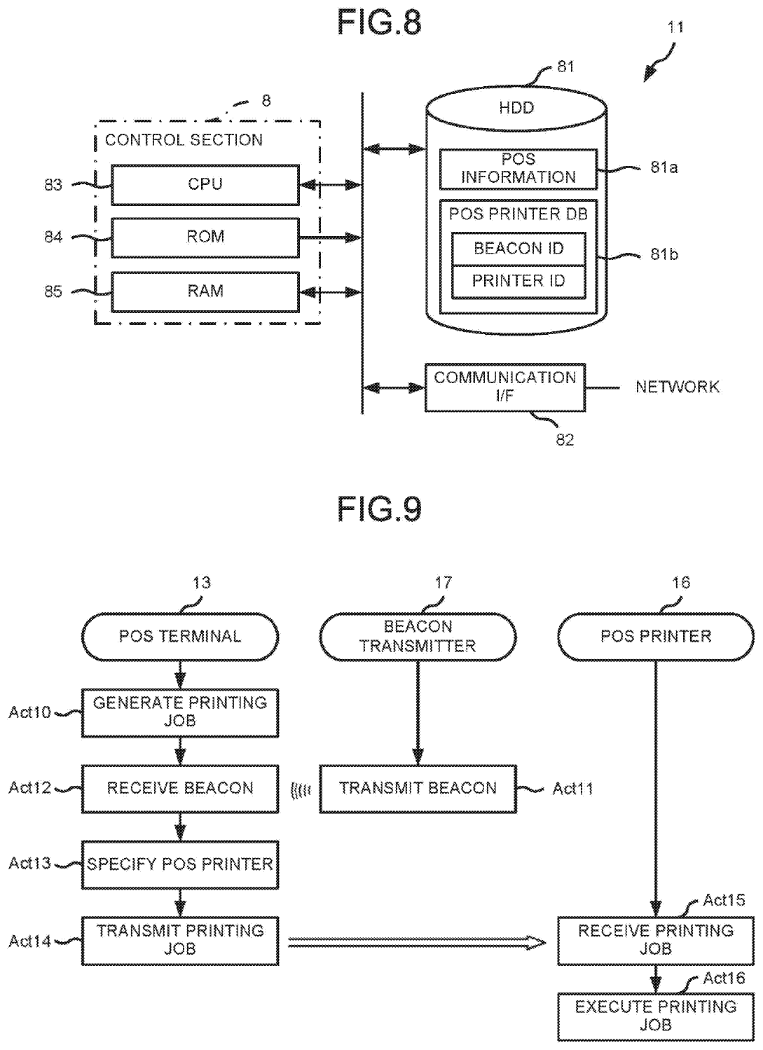

FIG. 8 is a block diagram of the POS server 11. The POS server 11 is an example of a server. The POS server 11 includes a control section 8, a storage device 81 and a communication interface 82. The respective components are mutually connected, for example via a system bus. The control section 8 comprises a CPU 83, a ROM 84 and a RAM 85. The CPU 83, the ROM 84 and the RAM 85 are arranged on, for example, a circuit board. The CPU 83 controls the overall operation of the POS server 11. The ROM 84 stores various programs and data. The RAM 85 stores various programs and data temporarily, and can rewrite various kinds of data.

The program stored in the ROM 84 includes an operating system and application programs for performing functions of the POS server 11. The CPU 83 reads the application program stored in the ROM 84 to execute it. The application programs include various programs for managing commodities sold in the retail store.

The storage device 81 is, for example, an HDD (Hard Disk Drive). The storage device 81 stores POS information 81a for collectively managing commodities sold in the retail store. The storage device 81 further stores a printer database 81b. The printer database 81b includes, for example, information in which a beacon ID of the beacon transmitter 17 is associated with a printer ID of the POS printer 16. As shown in FIG. 1, since the beacon transmitter 17 and the POS printer 16 are arranged to be one to one combination, if the beacon ID is known, it is possible to identify the POS printer 16 that is paired therewith. The beacon ID and the printer ID may not be different from each other, and may be a common ID. In recent years, since a smartphone generally has a function of receiving a beacon, the beacon ID may be encrypted if it is desired to enhance the security of the system.

The communication interface 82 is connected to the network 10. The communication interface 82 is connected to a communication device over the network 10 such as a router via a communication cable such as a LAN cable, for example. The control section 8 performs communication such as transmitting and receiving data with the tablet-type POS terminal 13 and the POS printer 16 via the network 10 and the communication interface 82.

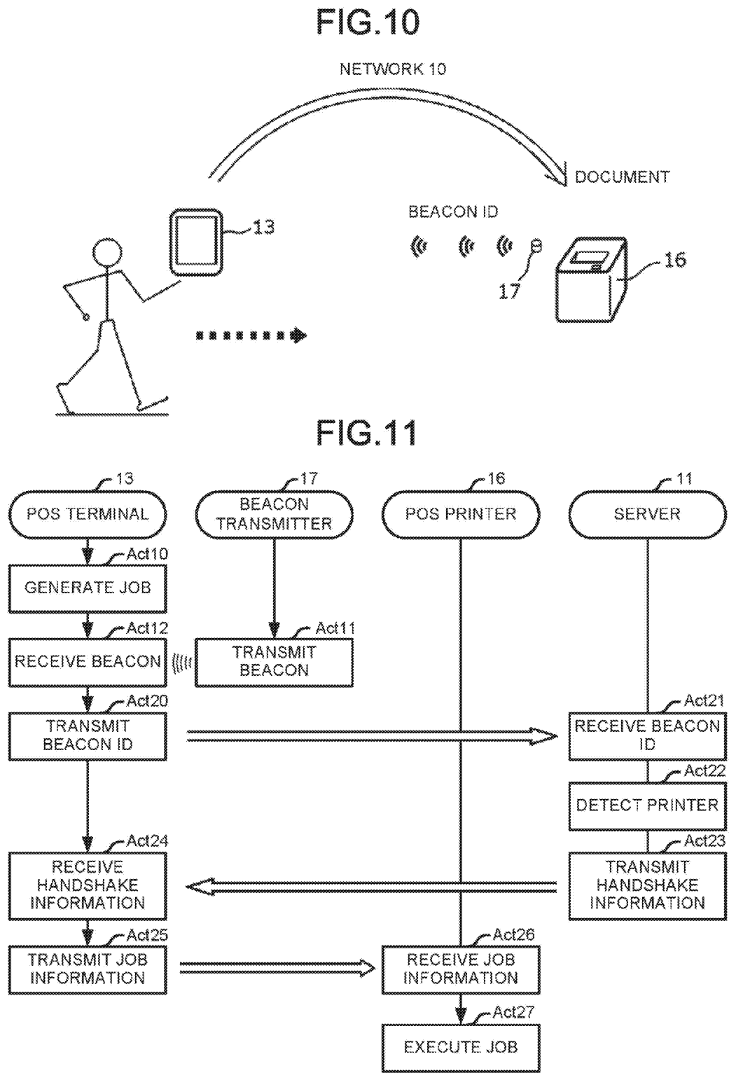

Next, with reference to FIG. 9 and FIG. 10, procedures for performing handshake between the tablet-type POS terminal 13 and the POS printer 16 using the beacon and printing a receipt R are described.

The tablet-type POS terminal 13 is, for example, carried by a store clerk, and performs registration and settlement of the commodity for, for example, a customer who purchases a small number of commodities, a children or elderly people in the retail store. Alternatively, the tablet-type POS terminal 13 is lent to the customer as a self-service device. The customer registers the commodity on the tablet-type POS terminal 13 before placing the commodity into a shopping cart, for example. For example, the tablet-type POS terminal 13 is returned to the store clerk, and the store clerk operates it to perform the settlement. If the registration and settlement of the commodity are completed, the tablet-type POS terminal 13 generates a printing job of the receipt R (Act 10). The printing job may be automatically generated when the settlement is completed. Alternatively, for example, the touch panel display 20 may be provided with a switch for issuing a receipt, the printing job may be generated when the switch is selected by a touch operation.

The store clerk who carries the tablet-type POS terminal 13 carries the tablet-type POS terminal 13 to approach the POS printer 16 in order to issue (receive) the receipt R from the closest POS printer 16, as schematically shown in FIG. 10. The beacon transmitter 17 continuously transmits beacons (Act 11). The tablet-type POS terminal 13 enters the coverage area of the beacon transmitter 17 paired with the POS printer 16 to receive the beacon (Act 12). Of course, if the tablet-type POS terminal 13 is already within the coverage area of the beacon transmitter 17, the tablet-type POS terminal 13 can receive the beacon on the spot.

If the beacon is received, the tablet-type POS terminal 13 executes the handshake application 25b, and extracts a beacon ID included in the beacon. When the beacon ID is encrypted, the tablet-type POS terminal 13 decrypts the beacon ID using a decryption key. After the beacon ID is extracted, the tablet-type POS terminal 13 extracts the printer ID of the POS printer 16 that is paired with the beacon ID to specify the POS printer 16 identified by the printer ID (Act 13). In order to quickly specify the POS printer 16, the printer database 81b stored in the POS server 11 may be stored in the tablet-type POS terminal 13 in advance. Of course, the tablet-type POS terminal 13 may request the POS server 11 to specify the printer. Then, the tablet-type POS terminal 13 performs handshake with the POS printer 16 to transmit information relating to the printing job (Act 14). In other words, in the case of the POS printer 16 in which mutual communication methods via the network 10 such as the communication speed and the data format are preset, the tablet-type POS terminal 13 transmits the information relating to the printing job via the network 10 according to the set communication method. In the case of the POS printer 16 in which the mutual communication method via the network 10 is not set, the tablet-type POS terminal 13 transmits the information relating to the printing job after the communication method via the network 10 with the POS printer 16 is established according to the handshake application 25b.

The POS printer 16 receives the information relating to the printing job via the network 10 (Act 15), and then executes the printing job (Act 16). The store clerk who carries the tablet-type POS terminal 13 hands the receipt R printed by the POS printer 16 over to the customer.

FIG. 11 shows a modification of the procedures for performing handshake between the tablet-type POS terminal 13 and the POS printer 16 using the beacon to print the receipt R. The modification has the same procedures as described in FIG. 9 until the tablet-type POS terminal 13 receives the beacon (Act 10 to Act 12). The tablet-type POS terminal 13 receiving the beacon executes the handshake application 25b to transmit the beacon ID extracted from the beacon to the POS server 11 via the network 10 and to request the POS server 11 to specify (detect) the POS printer 16 at the same time (Act 20).

The POS server 11 receives the beacon ID (Act 21) and refers to the printer database 81b to extract the printer ID of the POS printer 16 that is paired with the beacon ID, thereby specifying the POS printer 16 identified by the printer ID (Act 22). In addition, the POS server 11 may read communication information, such as an IP (Internet Protocol) address, necessary for communicating with the specified POS printer 16 via the network 10 from the printer database 81b. Then, the POS server 11 transmits information relating to the specified POS printer 16 as handshake information to the tablet-type POS terminal 13 via the network 10 (Act 23). The tablet-type POS terminal 13 receives the handshake information (Act 24), and transmits the information relating to the printing job to the POS printer 16 via the network 10 based on the handshake information (Act 25).

The POS printer 16 receives the information relating to the printing job via the network 10 (Act 26), and executes the printing job (Act 27). The store clerk holding the tablet-type POS terminal 13 delivers the receipt R printed by the POS printer 16 to the customer.

In order to enhance security, the beacon ID of the beacon transmitted from the beacon transmitter 17 may be encrypted, and the tablet-type POS terminal 13 may transmit the received beacon to the POS server 11 in a state in which the beacon is encrypted. The decryption is performed by the POS server 11.

According to the above-described embodiment, the beacon ID included in the beacon transmitted from the beacon transmitter 17 paired with the POS printer 16 is received and the POS printer 16 is specified to perform the handshake, and in this way, the user of the tablet-type POS terminal 13 can print the receipt R only by approaching the closest POS printer 16. In addition, since the handshake processing is started when the tablet-type POS terminal 13 enters the coverage area of the beacon, it can be expected that the printing of the receipt R is completed by the time point the user arrives at the POS printer 16. Furthermore, if the handshake application 25b is automatically executed in the background, it is possible to omit the time and effort taken on an operation by the user.

It is preferable that the coverage area of the beacon transmitted from the beacon transmitter 17 does not overlap with the coverage area of the beacon transmitted by another beacon transmitter 17. The coverage area of beacon transmitted from the beacon transmitter 17 is preferably, for example, within 3 meters in order to suppress interference by the beacon. When a plurality of beacons is received, it is preferable that the handshake application 25b in the tablet-type POS terminal 13 is used to execute the handshake with the nearby POS printer 16, i.e., the intensity of the received beacon is strong.

### Second Embodiment

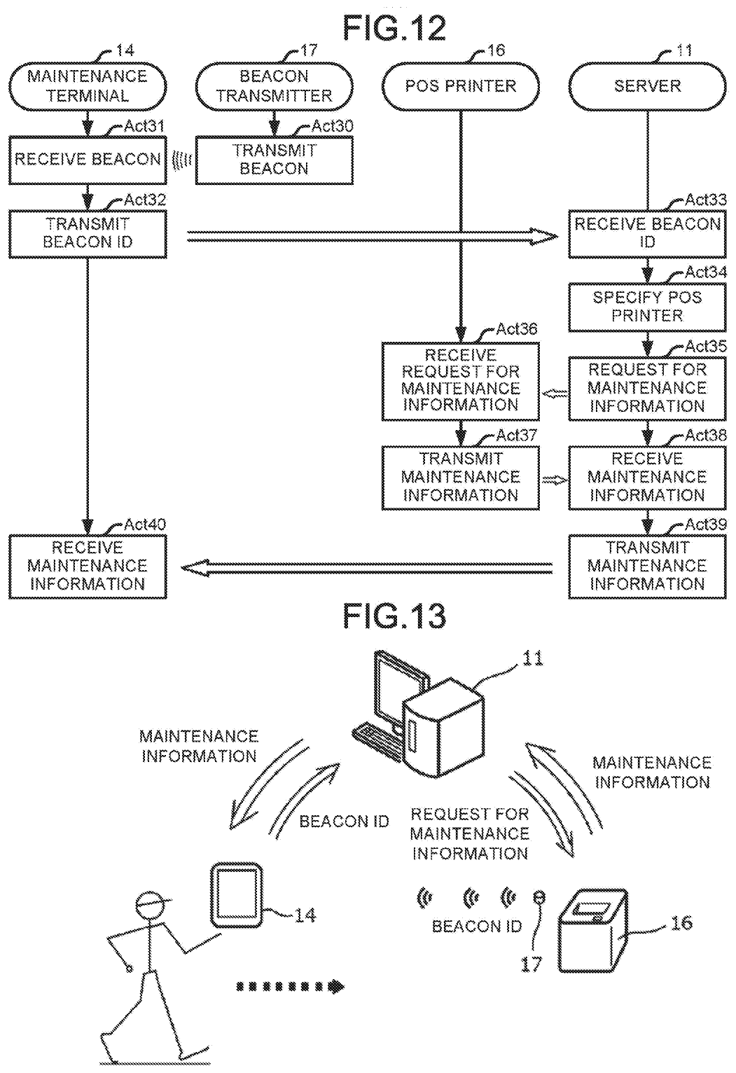

Next, with reference to FIG. 12 and FIG. 13, the procedures for performing the handshake between the maintenance terminal 14 and the POS printer 16 using the beacon to receive the maintenance information of the POS printer 16 are described.

A user of the maintenance terminal 14 is, for example, a service person in charge of maintenance service of the POS printer 16. The user of the maintenance terminal 14 needs maintenance information 63a of the POS printer 16 when performing a maintenance job. The latest maintenance information 63a of the POS printer 16 is stored in, for example, the RAM 63 of the POS printer 16. The maintenance information 63a includes, for example, a maintenance history, a health check result of the thermal head 47, a total length of the printed sheet S, or the like. The user who carries the maintenance terminal 14 approaches the POS printer 16 to be maintained, as schematically shown. The beacon transmitter 17 continuously transmits the beacons (Act 30). The maintenance terminal 14 enters the coverage area of the beacon transmitter 17 paired with the POS printer 16 to receive the beacon (Act 31). Of course, if the maintenance terminal 14 is already in the coverage area of the beacon transmitter 17, the maintenance terminal 14 can receive the beacon on the spot.

After receiving the beacon, the maintenance terminal 14 executes the maintenance application 35a to extract the beacon ID included in the beacon. If the beacon ID is extracted, the maintenance terminal 14 transmits the beacon ID extracted from the beacon to the POS server 11, and requests the POS server 11 to specify (detect) the POS printer 16 and transmit the maintenance information 63a (Act 32). The POS server 11 receives the beacon ID (Act 33) and refers to the printer database 81b to extract the printer ID of the POS printer 16 paired with the beacon ID, thereby specifying the POS printer 16 identified by the printer ID (Act 34).

The POS server 11 requests the maintenance information 63a from the specified POS printer 16 (Act 35). The POS printer 16 receives the request for the maintenance information 63a (Act 36) and reads the maintenance information 63a stored in, for example, the RAM 63 to transmit the maintenance information 63a to the POS server 11 (Act 37). The POS server 11 receives the maintenance information 63a (Act 38), and then transmits the maintenance information 63a to the maintenance terminal 14 (Act 39). Of course, the maintenance information 63a may be directly transmitted from the POS printer 16 to the maintenance terminal 14 without using the POS server 11. The maintenance terminal 14 receives the maintenance information 63a (Act 40), and displays the maintenance information 63a on the touch panel display 30. The user of the maintenance terminal 14 performs the maintenance job on the POS printer 16 based on the maintenance information 63a.

In order to enhance the security, the beacon transmitter 17 may encrypt the beacon ID. The maintenance terminal 14 may transmit the beacon ID to the POS server 11 in the encrypted state without having the decryption key of the beacon ID. In this case, the POS server 11 has a decryption key and decrypts the beacon ID. Furthermore, the POS server 11 may encrypt the maintenance information 63a and transmit it to the maintenance terminal 14, and meanwhile, for example, transmit an authentication code for decryption of the maintenance information 63a to another portable terminal that the maintenance person carries by e-mail or shot mail.

According to the above embodiment, since the beacon ID of the beacon transmitted from the beacon transmitter 17 paired with the POS printer 16 can be received, and the POS printer 16 can be specified to acquire the maintenance information 63a, the user of the maintenance terminal 14 can acquire the maintenance information 63a only by approaching the maintenance information 63. Moreover, since the handshake processing is started when the maintenance terminal 14 enters the coverage area of the beacon, it can be expected that the maintenance information 63a is displayed on the touch panel display 30 of the maintenance terminal 14 when the user arrives at the POS printer 16. Furthermore, if the maintenance application 25a is automatically executed in the background, the time and effort taken on operation by the user can be omitted.

The POS printer 16 is not limited to a thermal printer, but may be another type of printer such as an inkjet printer. Furthermore, although the POS printer 16 is described as an example of the image forming apparatus, the image forming apparatus is not limited to the printer.

The image processing system according to the embodiment is not limited to the POS system 1. The type of system is not limited as long as it includes the portable information processing apparatus, the image forming apparatus and the server.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image processing system, comprising:
an image forming apparatus comprising an image forming section that executes an image forming job and a communication section connected to a network;
a beacon transmitter configured to transmit a beacon including identification information for identifying the image forming apparatus; and
a portable information processing apparatus comprising a beacon receptor configured to receive a beacon including the identification information, a communication section configured to connect to the network, and a reception section configured to receive maintenance information via the network from an image forming apparatus identified by the identification information included in the received beacon if the portable information processing apparatus enters a coverage area of the beacon transmitter and receives the beacon.

2. The image processing system according to claim 1, wherein
the identification information for identifying the image forming apparatus and included in the beacon is transmitted in an encrypted state.

3. The image processing system according to claim 1, wherein
the beacon is a near field wireless communication signal.

4. The image processing system according to claim 1, comprising a plurality of beacons.

5. The image processing system according to claim 1, wherein
the image forming apparatus is a POS printer.

6. The image processing system according to claim 1, comprising a plurality of image forming apparatuses.

7. The image processing system according to claim 1, comprising a plurality of portable information processing apparatuses.

8. A portable information processing apparatus, comprising:
a beacon receptor configured to receive a beacon including identification information for identifying an image forming apparatus;
a communication section configured to connect to a network to which the image forming apparatus is connected; and
a reception section configured to receive maintenance information via the network from the image forming apparatus identified by the identification information included in the beacon if the portable information processing apparatus enters a coverage area of a beacon transmitter and receives the beacon.

9. The portable information processing apparatus according to claim 8, wherein the beacon is an encrypted beacon, further comprising:
a decryption key configured to decrypt the encrypted beacon.

10. The portable information processing apparatus according to claim 18, wherein the communication section is configured to connect to a wireless network.
